(19) United States
(12) Patent Application Publication
(10) Pub. No.: US 2018/0022161 A1
(43) Pub. Date: Jan. 25, 2018

(54) Tire With Directional Two-Material Tread, Comprising An Alternation Of Curved Blocks

(71) Applicant: COMPAGNIE GENERALE DES ETABLISSEMENTS MICHELIN, Clermont-Ferrand (FR)

(72) Inventor: Yann HYE, Clermont-Ferrand Cedex 09 (FR)

(21) Appl. No.: 15/551,668

(22) PCT Filed: Feb. 12, 2016
(86) PCT No.: PCT/EP2016/053042

§ 371 Date: Aug. 17, 2017

(30) Foreign Application Priority Data
Feb. 27, 2015 (FR) 15/00392

(51) Int. Cl. B60C 11/00; B60C 11/11; B60C 11/03

(52) U.S. Cl. CPC B60C 11/005; B60C 11/0302; B60C 11/0309; B60C 11/11; B60C 2011/0025

(57) ABSTRACT

Tire (1) comprising a directional tread (2) comprising a plurality of blocks (5), all or some of the blocks (5) comprising a median sipe (10) of length S, the tread being made up of a first rubber composition based on a diene elastomer, a reinforcing inorganic filler and a plasticizing system, wherein the first rubber composition has a glass transition temperature of between −40° C. and −15° C. and a shear modulus G* measured at 60° C. of between 0.5 MPa and 1.1 MPa, the tire comprising an intermediate layer that is situated under the tread and is in contact with a radially inner face of this tread, the intermediate layer comprising a second rubber composition having: hysteresis losses (P60) of between 9 and 20; and
a Shore A hardness of between 60 and 68.

### TECHNICAL FIELD OF THE INVENTION

The present invention relates to a tire provided with a directional tread that is suitable for wintry conditions involving for example roads covered with ice and/or snow, the tread being provided with a plurality of blocks in the form of curves aligned along the tread.

### PRIOR ART

The document U.S. Pat. No. 4,057,089 describes a tire comprising a tread provided with a plurality of blocks. Each of these blocks is arranged in a curved shape and extends from the centre of the tread to one of the edges. Some blocks are arranged in the shape of a curve in the form of a second degree parabola. The blocks are connected to a central strip. Since the blocks are relatively wide, the stiffness of these same blocks is consequently high, with the result that the tread rapidly becomes worn.

The invention provides various technical means for remedying these various drawbacks.

### SUMMARY OF THE INVENTION

First of all, a first object of the invention consists in providing a tire tread that makes it possible to improve durability.

Another object of the invention consists in providing a tire of which the tread makes it possible to reduce the rolling resistance.

Another object of the invention consists in providing a tread that makes it possible to obtain an excellent compromise between grip on snow-covered ground and grip on wet ground, while maintaining the performance on dry ground.

To this end, the invention provides a tire comprising a directional tread, said tread comprising two edges and a centre, this tread comprising a plurality of blocks, each block extending continuously along an overall curvature C from one of the edges towards the centre of said tread, forming a block central end, each block having a width WB and a length LB, this width increasing from the block central end towards the edge, all or some of the blocks of the tread comprising a median sipe of length S, said median sipe extending from the block central end along a curvature C′ substantially identical to the curvature C of the block, the tread being made up of a first rubber composition based on a diene elastomer, a reinforcing inorganic filler and a plasticizing system, wherein the first rubber composition has a glass transition temperature of between −40° C. and −15° C. and a shear modulus G* measured at 60° C. of between 0.5 MPa and 1.1 MPa, the tire comprising an intermediate layer that is situated under the tread and is in contact with a radially inner face of this tread, the intermediate layer comprising a second rubber composition having:
hysteresis losses (P60) of between 9 and 20;
a Shore A hardness of between 60 and 68.

Such an architecture, in particular by virtue of the intermediate layer and the composition thereof, makes it possible to reduce the rolling resistance.

Such a composition also allows use under wintry conditions with very cold temperatures without deterioration of the performance.

Furthermore, the Applicants have found, surprisingly, that the tread according to the invention, with an overall appearance of the blocks resembling a summer-type tire, has behavioural characteristics that are particularly advantageous on snow-covered and/or icy ground. The limits of this performance are favourably pushed back further with the use of the above-described compositions.

Furthermore, advantageous improvements in performance are observed when the glass transition temperature of the elastomer composition is between −20° C. and −30° C.

According to one advantageous embodiment, the second rubber composition comprises a nominal secant modulus at 10% elongation (MA10) of between 4 and 6 MPa.

According to another advantageous embodiment, the second rubber composition comprises a P60 of between 9 and 15 and a Shore A hardness of between 61 and 65.

According to yet another advantageous embodiment, with the tread having a mean thickness E and the intermediate layer having a mean thickness e, the mean thickness e of the intermediate layer has a value of between 25% and 60% of the mean thickness E of the tread.

According to one advantageous variant, with the tire comprising at least one groove in the tread and at least one wear indicator of height T protruding from the bottom of the groove, the intermediate layer extends, as seen in cross section through the tire, to a level corresponding at most to the height T of the wear indicator.

According to a further advantageous embodiment, the tire comprises, under the intermediate layer, a hooping layer in contact with this intermediate layer, the hooping layer comprising parallel reinforcers that are coated in a third rubber composition, said parallel reinforcers making an angle at most equal to 10° with a circumferential direction of the tire, and the intermediate layer laterally overhangs the hooping layer.

This layer provides protection for the region of the crown and also makes it possible to reduce the risk of cracking. Any incipient cracks cannot propagate through the rest of the tire. The crown plies are thus protected from any ingress of water that is likely to damage the tire.

Advantageously, the tire comprises electrically conductive means that extend through the tread from the surface of said tread to the hooping layer.

According to another advantageous embodiment, the length S of the median sipe is determined such that 0.5·LB≦S≦0.8·LB and the curvature C′ of the median sipe is determined such that the projection ratio Sx/Sy corresponds to 0.5≦Sx/Sy≦1.25, where Sx denotes the projection of the length S of the sipe along a circumferential axis X of the tread and Sy denotes the projection of this length S along a transverse axis Y of the tread.

Such an arrangement makes it possible to obtain an advantageous compromise between the characteristics of grip on snow-covered ground and grip on wet ground without a loss of performance for braking on dry ground. This effect is due to the coupled effect of the corners created by the sipes and the orientations thereof which have a frictional effect on the snow and thus improve grip. The presence of the sipe and the orientation thereof make it possible to improve the grip on snow-covered ground on account of the corners. Furthermore, the sipe interruption zone makes it possible to increase the stiffness along the axis X and to improve braking on dry ground.

This tire is advantageously provided for all-season use.

According to one advantageous embodiment, all or some of the blocks of the tread comprise a generally circumferential sipe arranged at the opposite end of the median sipe from the block central end, said generally circumferential sipe extending from one edge of the block to the other.

This sipe promotes the flattening of the tire by virtue of the decoupling created. The shoulder stiffness is maintained, however, in order to allow good road holding on cornering.

According to one advantageous embodiment, the circumferential sipe is V-shaped, with the tip forming an angle a of between 100° and 170° and preferably between 150° and 170°. In a variant, the circumferential sipe is in the overall shape of an “S”. In another variant, this sipe may comprise several small segments while maintaining a generally circumferential orientation.

Likewise advantageously, all or some of the blocks of the tread furthermore comprise at least one lateral sipe that is arranged in continuation of the median sipe and decoupled from the latter and from the transverse sipe.

This sipe allows an increase in the number of corners in the shoulder zone and consequently improves braking and driveability on snow-covered roads. Decoupling makes it possible to maintain a degree of stiffness in the block.

According to one advantageous embodiment, the lateral sipe widens from a certain tread-pattern depth, forming a sipe widening, the sipe widening opening onto the shoulder of the tire, beyond the edge of the tread.

This sipe widening makes it possible to extend the favourable characteristics of grip on snow-covered ground in spite of the wear to the blocks, down for example to a block height of around 3 mm. Furthermore, the droplet-shaped profile makes it possible to store water and promotes the performance on wet ground.

According to one advantageous embodiment, at least some of the median sipes comprise a sipe chamfer. The sipe chamfer is advantageously located in the intermediate zone. In a variant, it extends as far as the generally circumferential sipe.

According to another advantageous embodiment, at least some of the blocks are arranged with a block chamfer provided at the trailing edge of the intermediate zone and/or of the edge zone. Preferably, these chamfers are 45°-chamfers with a section of between 1×1 mm and 2×2 mm. They can also be formed by a radius (1 to 2 mm) joined to the faces of the blocks.

According to another advantageous embodiment, at least some of the median sipes comprise stiffening means which connect, for each sipe, the opposite faces of this sipe. The stiffening means are particularly advantageous in the central zone, this zone having the greatest angle with respect to the transverse direction (Y).

The stiffening means are preferably arranged in the sipe at spacings of 5 to 20 mm. The height of the stiffening means is preferably between 40 and 80% of the maximum height of the sipes. Thus, these stiffening means do not extend as far as the surface of the tread when the tire is new.

Advantageously, in at least one sipe, the spacing between the stiffening means is variable.

Likewise advantageously, the stiffening means are integral with the tread.

### DESCRIPTION OF THE FIGURES

All the embodiment details are given in the description which follows, which is supplemented by FIGS. 1 to 3, which are given solely by way of non-limiting examples and in which:

FIG. 1 is a schematic depiction of a portion of a tread corresponding substantially to the contact patch;

FIG. 2 is a schematic depiction of a block for a tread such as the one in FIG. 1;

FIG. 3 is a schematic depiction in cross section of a portion of the crown region of a tire according to the invention.

### DETAILED DESCRIPTION OF THE INVENTION

### Definitions

In the present document, curved length “L” or “S” means a length measured taking the curvature of the “L”- or “S”-shaped element measured into account.

A “directional tread pattern” means a tread pattern in which the tread pattern elements are specifically arranged to optimize the behavioural characteristics depending on a predetermined sense of rotation. This sense of rotation is conventionally indicated by an arrow on the sidewall of the tire. In such an architecture, the edges of the tread pattern elements which face in the rolling direction are denoted by the term “leading edge”, while the edges of the tread pattern elements which face away from the rolling direction are denoted by the term “trailing edge”. In addition, a “directional tread pattern” is a tread pattern that implies a preferred rolling sense such that, when the tire is rotated in said preferred sense, this tire affords properties of grip on the ground that are better than those afforded when said tire is rotated in the other sense. A directional tread pattern is for example a tread pattern having patterns in the overall shape of a V.

A “sipe” means an elongate and thin (between 0.1 and 2 mm) slit or cutout made in a tread block.

A “median sipe in the block” means that this median sipe separates this block into two generally identical block parts. Since the difference in area between these two block parts is less than 10%, the area is understood to mean that which can come into contact with the ground in the contact patch.

A “lateral sipe” means a sipe which extends generally in the transverse direction Y, the angle formed by the direction of extension of this sipe with the transverse direction Y being less than 15 degrees in absolute terms.

A “lateral sipe decoupled from the median sipe” means that there is an area of rubber between the lateral sipe and the median sipe. The length of this area of rubber is at least 2 mm.

A “circumferential sipe” means a sipe which extends generally in the circumferential direction X, the angle formed by the direction of extension of this sipe with the circumferential direction X being less than or equal to 20 degrees in absolute terms.

The expression “each block extending continuously from one edge 3 towards the centre 4” means that the block is not interrupted by separating grooves that separate this block into different sub-blocks. A groove means a cutout, the material faces of which do not touch under normal rolling conditions. The width of a groove is greater than or equal to 2 mm. Thus, the fact that these blocks are not interrupted by separating grooves makes it possible to improve the evacuation of water from the centre 4 towards the edge 3, the presence of such separating grooves being able to disrupt the flow of water towards the outside of the tire.

The expression “overall curvature C of the block” means that the block has a curved shape. This curvature can be constant or continuously variable. In another variant, the curvature is formed by a succession of segments.

The expression “overall curvature C′ of the median sipe” means that the median sipe follows a curved line. This curvature can be constant or continuously variable. In another variant, the curvature is formed by a succession of segments.

A “tread” means the region of the tire of which at least a part is made to come into contact with the ground and is worn away by this contact with the ground.

### Measuring Modes

The expression “Shore A hardness” means the hardness of the compositions after curing, which is assessed in accordance with the ASTM D 2240-86 standard.

The nominal secant moduli (or apparent stress, in MPa) are measured in second elongation (i.e. after an accommodation cycle at the extension rate provided for the measurement itself) at 10% elongation (denoted MA 10) and at 100% elongation (denoted MA 100) at 23° C.±2° C., and under normal hygrometry conditions (50%±5% relative humidity) in accordance with the ASTM D-412 standard.

The hysteresis losses, denoted P60, are measured as percentage rebound at the sixth rebound at 60° C. in accordance with the following equation: HL(%)=100.{(WOW1)/W1} in which WO is the energy supplied and W1 is the energy returned.

### DESCRIPTION OF THE FIGURES

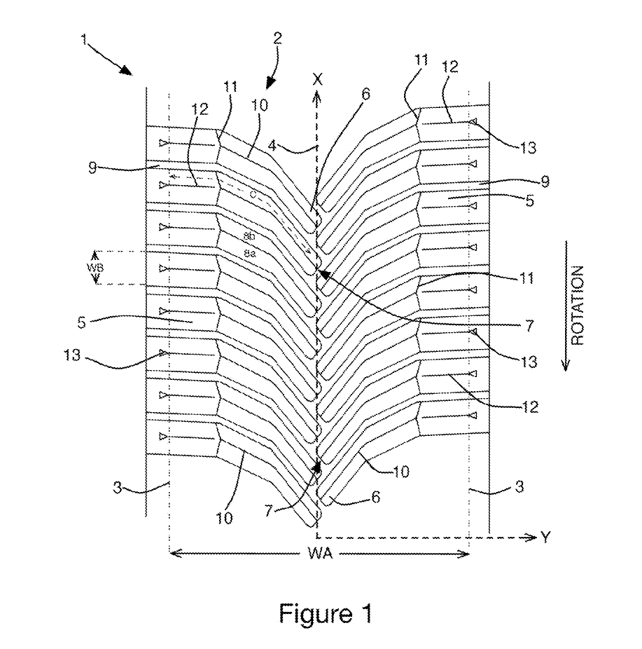

FIG. 1 illustrates the contact patch of a tread 2 of a tire 1. The contact patch has a maximum width WA that is defined by the ETRTO standard and illustrated in FIG. 1 between the dotted lines delimited by the width WA. The ETRTO standard provides a width WA=(1.075-0.005ar)*S^{1.001} where “ar” is the nominal aspect ratio and S is the theoretical section width on the measuring rim. The edges 3 of the tread correspond to the dotted lines delimiting the width WA.

According to the invention, the tread 2 comprises a plurality of blocks 5. Each of the blocks extends from one edge 3 of the tread towards the central axis 4 of the tread, generally following a curvature C. The expression “towards the centre” means in this case that the block ends in the region of the centre, or just before the centre or just after the centre. The centre 4 is defined by a line that extends in the circumferential direction and divides the tread into two halves. For wide tire sizes, a longitudinal furrow can be added at this centre 4.

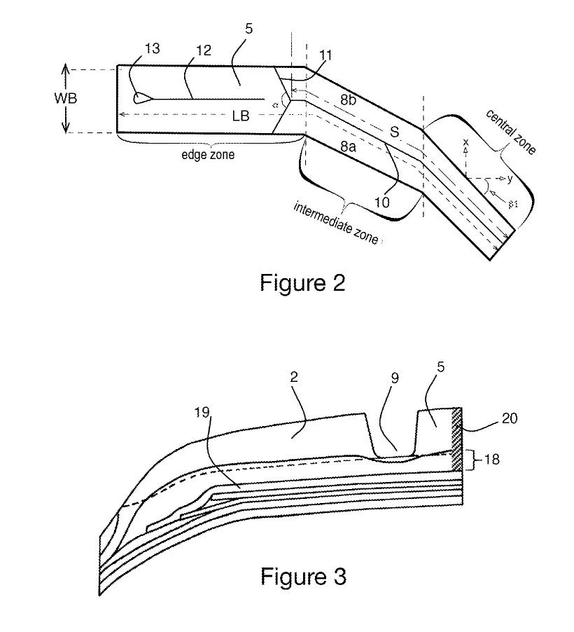

Each of the blocks has a length LB and a width WB, this width increasing from the block central end in the direction of the edge 3. The blocks are advantageously configured in three zones, namely a central zone, an intermediate zone and an edge zone. The central zone makes an angle β1 of between 35° and 65° and more preferably around 50°+−5° with respect to the transverse direction (Y). At the periphery of the blocks, there is an edge zone that makes an angle β3 of between 0° and 10° with respect to the transverse direction (Y). In order to ensure a continuous connection between these two zones, an intermediate zone is provided. This intermediate zone makes it possible to ensure the connection between the central zone and the edge zone with an angle β2 allowing continuity between the three zones. On account of this arrangement in three zones, the blocks have a curvature C, which is progressive from the edge 3 in the direction of the centre 4. In order to shape this curvature, the sides of the blocks form, depending on the case, either a continuous curved line from the edges 3 towards the centre 4, this curvature being able to be variable, or a plurality of angled segments, as shown in FIG. 2. In the case in which a block zone is configured by a succession of segments, the angle β is the mean angle. In the case in which a block zone is configured by a curved segment, the angle β corresponds to the mean of the angles along the curvature.

At least some of the blocks 5 comprise a median sipe 10 that extends along the block along a curvature C′ similar to the curvature C of the block. This sipe makes it possible to separate the block into two parts 8a and 8b, with preferably substantially identical areas. In a variant, only some of the blocks 5 comprise a median sipe 10.

The median sipe 10 makes it possible to reduce the stiffness of the block 5 by separating it into two half-blocks. The stiffness of each half-block is substantially identical, helping to make the wearing of these two half-blocks uniform. The median sipe 10 has a curved length S. This length S of the median sipe is preferably determined such that 0.5·L≦S≦0.8·L.

According to the invention, at least some of the blocks 5 comprise a generally circumferential sipe 11 arranged at the end of the median sipe 10. The expression “generally circumferential” means an arrangement such that the projection ratio Ry/Rx corresponds to 0≦Ry/Rx≦0.6. This sipe produces a decoupling effect that promotes the flattening of the tire.

The examples in FIGS. 1 and 2 illustrate V-shaped generally circumferential sipes 11, the tip of the V of which makes an angle a of between 100° and 170° and preferably between 150° and 170°. Depending on the embodiment, the tip of the V can be oriented either towards the centre of the tread or towards the proximal edge of the tread. A V-shaped sipe makes it possible to improve grip in the longitudinal and transverse directions.

Finally, the blocks 5 provide at least one lateral sipe 12, which is arranged in the block edge zone. This sipe is offset transversely with respect to the median sipe 10 and the circumferential sipe 11. The offset between this sipe and the other sipes is preferably between 3 and 6 mm. This offset, by locally increasing the stiffness, helps to improve the braking effectiveness on dry ground.

Preferably, this lateral sipe 12 widens from a certain tread pattern depth, forming a sipe widening 13. This sipe widening 13 opens onto the shoulder of the tire and forms a droplet-shaped profile.

Advantageously, the sipes 10 and 12 are arranged at the neutral fibre of the blocks, that is to say so as to separate the blocks into two parts with substantially identical volumes.

The depth of the sipes is preferably between 85% and 105% of the depth of the grooves delimiting the blocks.

FIG. 3 shows a cross section of a portion of a crown of a tire according to the invention, in which an intermediate layer 18 is provided under the tread and in contact with a radially inner face of the tread.

In the example illustrated, a hooping layer 19 is disposed under the intermediate layer 18 and is in contact with this intermediate layer. The hooping layer 19 provides parallel reinforcers that are coated in an elastomeric compound. The reinforcers are aligned substantially in the circumferential direction, that is to say that they form an angle of at most 10° with this direction.

The tread is made up of a first rubber composition based on a diene elastomer, a reinforcing inorganic filler and a plasticizing system. This first rubber composition has a glass transition temperature of between −40° C. and −15° C. and a shear modulus G* measured at 60° C. of between 0.5 MPa and 1.1 MPa.

The diene elastomer is selected from the group comprising natural rubber, stirene-butadiene rubber, synthetic polyisoprene rubber, polybutadiene rubber and any combinations of these constituents. The plasticizing system comprises plasticizers selected from a plasticizing oil, a plasticizing resin or any combination of these constituents.

The plasticizing resin is a polylimonene resin. The plasticizing oil is selected from a petroleum-based oil, a vegetable oil, or any combination of these oils.

The intermediate layer 18 comprises a second rubber composition having hysteresis losses (P60) of between 9 and 20 and a Shore A hardness of between 60 and 68. Furthermore, the second rubber composition comprises a nominal secant modulus at 10% elongation (MA10) of between 4 and 6 MPa. The second rubber composition comprises an MA10 of 4.4, a P60 of 12.5 and a Shore A hardness of 63.

The reinforcers of the hooping layer 19 are coated in a third rubber composition. The intermediate layer 18 surrounds the hooping layer 19.

With the tread having a mean thickness E and the intermediate layer having a mean thickness e, the mean thickness e of the intermediate layer 18 has a value of between 25% and 60% of the mean thickness E of the tread.

The tire according to the invention comprises a wear indicator of height T protruding from the groove 9. As seen in cross section through the tire, the intermediate layer 18 extends towards the tread to a level corresponding at most to the height T of the wear indicator. Locally, overshoots that are inherent to the production process can be tolerated.

The tire comprises electrically conductive means 20 that extend through the tread from the surface of said tread to the hooping layer 19. In the example illustrated, the conductive means are in the form of a circumferential insert. The compound making up this insert is provided so as to ensure a good level of electrical conductivity. The insert makes it possible to ensure good electrical conductivity between the hooping layer 19 and the ground when the elastomer compound of the tread does not provide sufficient electrical conductivity.

The figures and their descriptions given above illustrate the invention rather than limit it. In particular, the invention and the different variants thereof have just been described in relation to a particular example comprising identical blocks over the entire surface of the tread.

However, it is obvious to a person skilled in the art that the invention can be extended to other embodiments in which, in variants, non-identical blocks are provided either along the circumferential alignment or on either side of the central line of the tread. It is also possible to provide for at least one of the ends of the median sipes 10 to comprise a bridge in the central part of the tread and/or between the median sipe and the circumferential sipe.

The reference signs in the claims are entirely non-limiting. The verbs “comprise” and “have” do not exclude the presence of elements other than those listed in the claims.

### REFERENCE NUMERALS EMPLOYED IN THE FIGURES

1 Tire
2 Tread
3 Tread edge
4 Central axis of tread
5 Block
6 Central end of the block
7 Central end wall of the block
8a Leading-edge part of the block
8b Trailing-edge part of the block
9 Groove
10 Median sipe
11 Generally circumferential sipe
12 Lateral sipe
13 Depthwise sipe widening
18 Intermediate layer
19 Hooping layer
20 Conductive insert

1. A tire comprising a directional tread, said tread comprising two edges and a centre, this said tread comprising a plurality of blocks, each block extending continuously along an overall curvature C from one of the edges towards the centre of said tread, forming a block central end, each said block having a width WB and a length LB, said width increasing from the block central end towards the edge, all or some of the blocks of the tread comprising a median sipe of length S, said median sipe extending from the block central end along a curvature C′ substantially identical to the curvature C of the block, the tread being comprised of a first rubber composition based on a diene elastomer, a reinforcing inorganic filler and a plasticizing system, wherein the first rubber composition has a glass transition temperature of between −40° C. and −15° C. and a shear modulus G* measured at 60° C. of between 0.5 MPa and 1.1 MPa, wherein the tire comprises an intermediate layer that is situated under the tread and is in contact with a radially inner face of said tread, and wherein the intermediate layer comprises a second rubber composition having:
hysteresis losses (P60) of between 9 and 20;
a Shore A hardness of between 60 and 68.

2. The tire according to claim 1, wherein the second rubber composition comprises a nominal secant modulus at 10% elongation of between 4 and 6 MPa.

3. The tire according to claim 1, wherein the second rubber composition comprises a P60 of between 9 and 15 and a Shore A hardness of between 61 and 65.

4. The tire according to claim 1, with the tread having a mean thickness E and the intermediate layer having a mean thickness e, wherein the mean thickness e of the intermediate layer has a value of between 25% and 50% of the mean thickness E of the tread.

5. The tire according to claim 1, comprising a groove in the tread and a wear indicator of height T protruding from the bottom of the groove, wherein the intermediate layer extends, as seen in cross section through the tire, to a level corresponding at most to the height T of the wear indicator.

6. The tire according to claim 1, wherein the tire comprises, under the intermediate layer, a hooping layer in contact with said intermediate layer, the hooping layer comprising parallel reinforcers that are coated in a third rubber composition, said parallel reinforcers making an angle at most equal to 10° with a circumferential direction of the tire, and wherein the intermediate layer laterally overhangs the hooping layer.

7. The tire according to claim 1, wherein said tire comprises electrically conductive means that extend through the tread from the surface of said tread to the hooping layer.
